(19) United States
(12) Patent Application Publication
(10) Pub. No.: US 2019/0386553 A1
(43) Pub. Date: Dec. 19, 2019

(54) WEARABLE ELECTRONIC DEVICE

(71) Applicant: Acer Incorporated, New Taipei City (TW)

(72) Inventors: Jia-Yu Lin, New Taipei City (TW); Jin-Ting Kuo, New Taipei City (TW)

(73) Assignee: Acer Incorporated, New Taipei City (TW)

(21) Appl. No.: 16/114,244

(22) Filed: Aug. 28, 2018

(30) Foreign Application Priority Data
Jun. 14, 2018 (TW) 107120489

(51) Int. Cl. H02K 35/02; H02K 11/04; H02K 11/00

(52) U.S. Cl. CPC H02K 35/02; G06F 1/163; H02K 11/0094; H02K 11/046

(57) ABSTRACT

A wearable electronic device including an electromagnetic induction generator, a rectifier circuit, and an energy storage is provided. The electromagnetic induction generator includes a magnet and a flexible thin film. The flexible thin film is provided with an induction coil. When a relative position between the magnet and the induction coil changes, a magnetic flux passing through the induction coil changes so that an induced current is generated. The rectifier circuit is electrically connected between the induction coil and the energy storage and is configured to receive the induced current to charge the energy storage.

### CROSS-REFERENCE TO RELATED APPLICATION

This application claims the priority benefit of Taiwan application serial no.

107120489, filed on Jun. 14, 2018. The entirety of the above-mentioned patent application is hereby incorporated by reference herein and made a part of this specification.

### BACKGROUND

### Technical Field

The invention relates to a wearable electronic device. More particularly, the invention relates to a wearable electronic device capable of converting kinetic energy into electrical energy.

### Description of Related Art

Along with rapid technology advancement, types and functions of electronic devices become more and more diverse, and smart electronic devices become a major role in everyday life. For instance, portable electronic devices can be connected to other electronic devices through the Internet of Things (IoT) technologies, so as to provide more complete services. In order to allow users to carry around the portable electronic devices more conveniently, the wearable electronic products are thus developed.

Nowadays, smart wristbands, smart watches and the like are the common wearable electronic devices, and such wearable electronic devices are suitable for being worn by users for a long period of time. The existing wearable electronic devices use rechargeable batteries and thus may run out of electricity after being used for a period of time. Moreover, thin and lightweight design are important features of the wearable electronic devices. Nevertheless, technical difficulties are observed in the development of current battery technology. Hence, if battery capacity is to be expanded, volume or weight of the wearable electronic devices is still an issue which requires to be taken into consideration. Besides, users may feel inconvenient when they have to frequently take off the wearable electronic devices for charging.

Therefore, how to enable the wearable electronic devices to be used for a longer period of time without affecting the convenience of using the wearable electronic devices and the sizes and weight of the wearable electronic devices is an important issue.

### SUMMARY

The invention provides a wearable electronic device capable of converting kinetic energy into electrical energy, featuring lightweight and a compact size, and capable of being used for an extended period of time with limited costs.

A wearable electronic device provided by an embodiment of the invention includes an electromagnetic induction generator, a rectifier circuit, and an energy storage. The electromagnetic induction generator includes a magnet and a first flexible thin film. The first flexible thin film is provided with an induction coil. When a relative position between the magnet and the induction coil changes, a magnetic flux passing through the induction coil changes so that an induced current is generated. The rectifier circuit is electrically connected between the induction coil and the energy storage and is configured to receive the induced current to charge the energy storage.

To sum up, the wearable electronic device provided by the embodiments of the invention includes the electromagnetic induction generator, so as to provide electric power required by the wearable electronic device. The induction coil is disposed at the first flexible thin film, so that the induction coil may be densely packed while delivers reduced volume. Hence, when the wearable electronic device is moved, kinetic energy is converted into electrical energy and the electrical energy is saved by adopting the electromagnetic induction principle. In the wearable electronic device provided by the embodiments of the invention, the densely-packed induction coil can be generated in limited volume without considerably high manufacturing costs. Moreover, additional electric power is provided for the wearable electronic device so that the wearable electronic device may be used for a longer period of time. Therefore, the wearable electronic device not only features environmental protection and energy saving but also features enhanced user convenience since a user does not have to put on or take off the wearable electronic device often for charging.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a schematic view of a wearable electronic device according to an embodiment of the invention.

FIG. 1B is a schematic circuit block diagram of the wearable electronic device of FIG. 1A.

FIG. 2 is a schematic diagram of a scenario illustrating movement of a magnet following movement of the wearable electronic device of FIG. 1A.

FIG. 3A is a schematic side view of a first flexible thin film according to an embodiment of the invention.

FIG. 3B is a schematic top view of the first flexible thin film of FIG. 3A according to an embodiment of the invention.

FIG. 4 is a schematic view of an induction coil formed through the first flexible thin film of FIG. 3A.

FIG. 5 is a schematic side view of a first flexible thin film according to another embodiment of the invention.

FIG. 6A is a schematic side view of a first flexible thin film and a second flexible thin film according to another embodiment of the invention.

FIG. 6B is a schematic top view of the first flexible thin film and the second flexible thin film of FIG. 6A according to an embodiment of the invention.

FIG. 7 is a schematic view of the induction coil according to an embodiment of the invention.

FIG. 8A to FIG. 8D are schematic diagrams of a connecting process of the first flexible thin film and the second flexible thin film of FIG. 6A according to an embodiment of the invention.

FIG. 9 is a schematic diagram of the connecting process with the first flexible thin film and the second flexible thin film of FIG. 8B being spread.

FIG. 10 is a schematic exploded view of an electromagnetic induction generator according to an embodiment of the invention.

### DESCRIPTION OF THE EMBODIMENTS

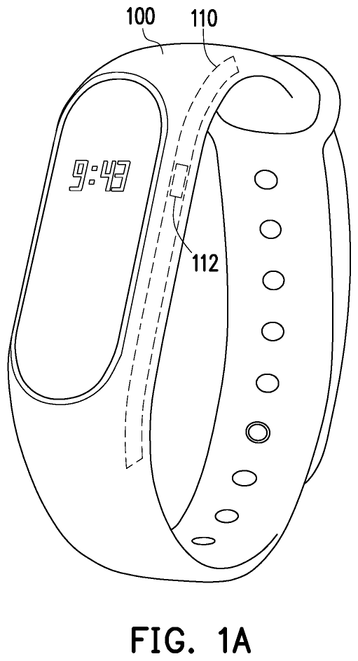

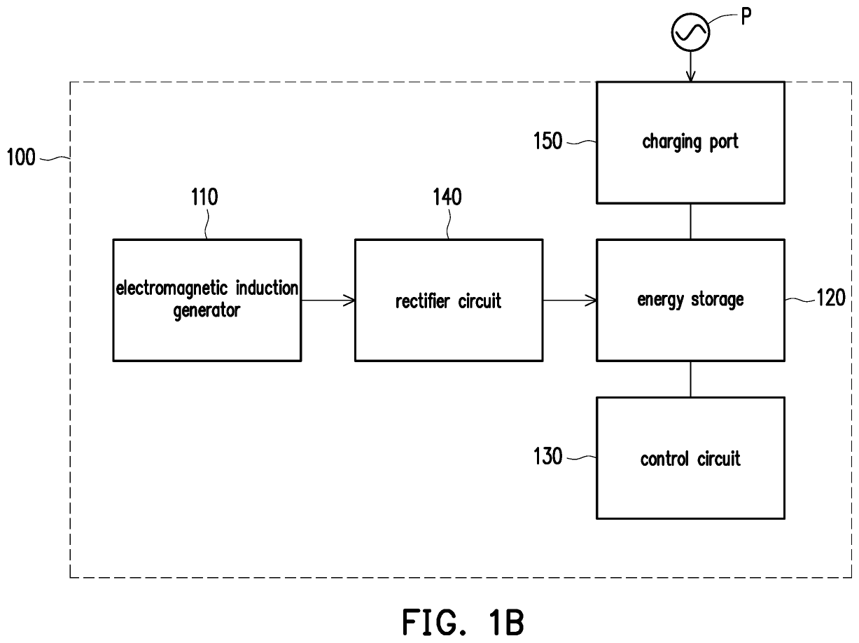

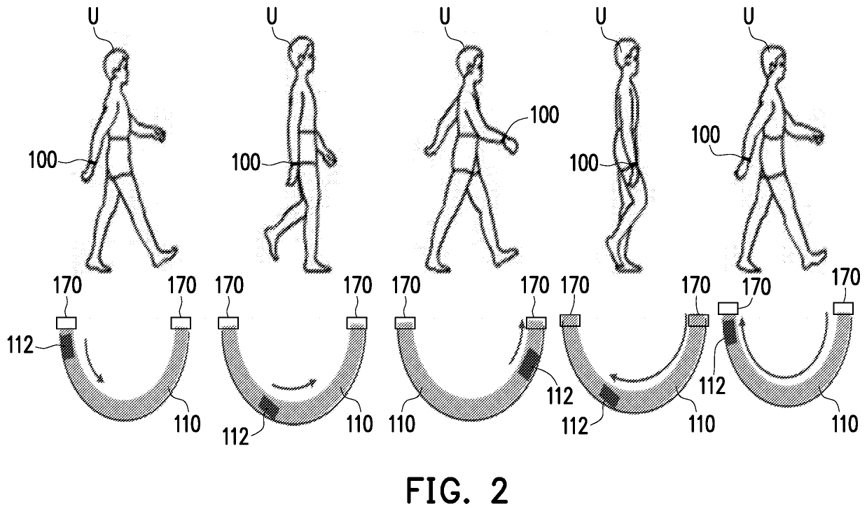

FIG. 1A is a schematic view of a wearable electronic device according to an embodiment of the invention, FIG. 1B is a schematic circuit block diagram of the wearable electronic device of FIG. 1A, and FIG. 2 is a schematic view of movement of a magnet following movement of the wearable electronic device of FIG. 1A. With reference to FIG. 1A and FIG. 2, a wearable electronic device 100 of this embodiment, for example, a smart watch, is adapted for being worn on a user U, but types of the wearable electronic device 100 are not limited thereto. In other embodiments, the wearable electronic device 100 may be a smart wristband, a smart necklace, and the like or may be a wearable electronic device to be worn on other parts of the user. The invention is not intended to limit how the wearable electronic device 100 is disposed or used.

The wearable electronic device 100 includes an electromagnetic induction generator 110, an energy storage 120, and a rectifier circuit 140. The electromagnetic induction generator 110 includes a magnet 112 and a first flexible thin film (not shown in FIG. 1A to FIG. 2) provided with an induction coil, and the magnet 112 is disposed to be move freely relative to the induction coil. With reference to FIG. 2, when the user U swings his/her arms, the wearable electronic device 100 moves as well, and the magnet 112 correspondingly moves relative to the induction coil owing to factors such as inertia, acceleration, or gravity. Hence, when the wearable electronic device 100 is moved, a relative position between the magnet 112 and the induction coil changes, as such, a magnetic flux passing through the induction coil changes so that an induced current is generated. The rectifier circuit 140 is electrically between the induction coil and the energy storage 120 and is configured to receive the induced current from the electromagnetic induction generator 110 and convert the induced current into electrical energy, so as to charge the energy storage 120.

In an embodiment of the invention, the induction coil is disposed at the first flexible thin film, and a plurality of first conductive lines are included on a surface of the first flexible thin film. To be specific, the induction coil is made of at least one of an organic conductive polymer film, an indium tin oxide conductive film, metal, a carbon nanotube, and graphene and is formed on the first flexible thin film through at least one of roll-to-roll printing and screen printing. Though technologies such as the roll-to-roll printing technology or the screen printing technology, extremely thin conductive lines and a variety of patterns can be manufactured on the surface of the first flexible thin film, and the first flexible thin film can also be rolled up to allow the first conductive lines to be connected into the induction coil. For instance, a width of a conductive line is less than or equal to 5 microns (μm). Therefore, unlike existing induction coils which are formed by using bent metal conduction lines, the induction coil provided by the embodiments of the invention features reduced volume and a high turn number and can be manufactured without considerable manufacturing costs.

Further, with reference to FIG. 1A and FIG. 1B, the wearable electronic device 100 further includes a control circuit 130 and a charging port 150. The charging port 150 is electrically connected to the energy storage 120 to be electrically connected to an external power source P. The energy storage 120 receives electrical energy provided by the external power source P through the charging port 150 to be charged. The energy storage 120 can be charged through a wired or wireless manner, which is not limited by the invention.

The energy storage 120 is coupled to the electromagnetic induction generator 110 through the rectifier circuit 140. After the user U shakes or swings the wearable electronic device 100 to cause the electromagnetic induction generator 110 to generate the induced current, the energy storage 120 receives the rectified induced current through the rectifier circuit 140 and stores the rectified induced current as the electrical energy. Therefore, in this embodiment, the energy storage 120 can store the electrical energy transmitted by an external device as well as the electrical energy generated by converting kinetic energy of the wearable electronic device 100.

The following provides a detailed description of a method of forming the induction coil through the first flexible thin film.

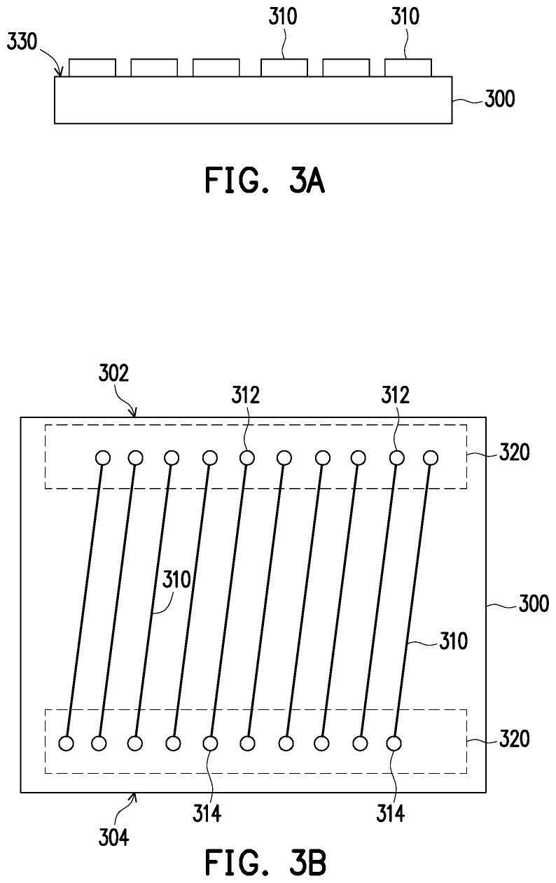

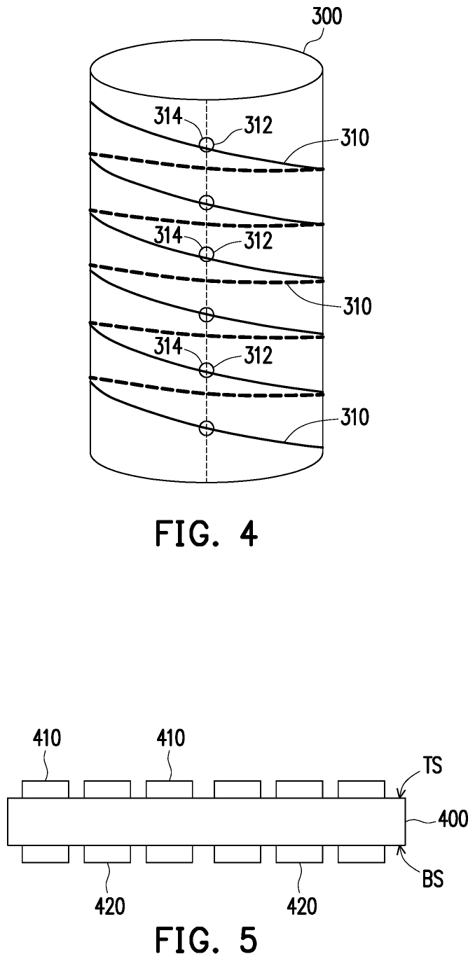

FIG. 3A is a schematic side view of a first flexible thin film according to an embodiment of the invention, FIG. 3B is a schematic top view of the first flexible thin film of FIG. 3A according to an embodiment of the invention, and FIG. 4 is a schematic view of an induction coil formed through the first flexible thin film of FIG. 3A. With reference to FIG. 3A to FIG. 4, a plurality of first conductive lines 310 are disposed on a surface 330 of a first flexible thin film 300. Each of the first conductive lines 310 has two end points, an end point 312 and an end point 314, and the end points are located in bonding regions 320. In this embodiment, the first conductive lines 310 are arranged in rows extending from one side of the surface 330 to an opposite side. Herein, the first conductive lines 310 are exemplified as extending from an upper side 302 to a lower side 304. When the first flexible thin film 300 is horizontally disposed, at least two of the first conductive lines 310 are not electrically connected (as shown in FIG. 3B).

In the embodiment of FIG. 4, when the first flexible thin film 300 is rolled up into a cylinder-shaped structure, the first conductive lines 310 are electrically connected to form an induction coil. In this way, the magnet 112 can move relative to the cylinder-shaped structure, as such, the induction coil generates an induced current.

In order to form the cylinder-shaped structure, the first flexible thin film 300 is rolled up, and two opposite sides (e.g., the upper side 302 and the lower side 304) of the surface 330 are connected. To be specific, connecting the two opposite sides of the first flexible thin film 300 refers to overlapping the two bonding regions 320. Moreover, each of the end points 312 and the end points 314 are electrically connected through a conductive paste. For instance, end point 312 of one first conductive line 310 is connected to the end point 314 of the neighboring first conductive line 314. It can thus be seen that the first conductive lines 310 are connected end to end to from a continuous spiral coil to act as the induction coil, as shown in FIG. 4. The magnet 112 is disposed in a way to be able to move in the cylinder-shaped structure (the magnet 112 is not shown in FIG. 4).

For instance, the conductive paste is a conductive material such as an anisotropic conductive film (ACF) or a conductive silver paste and the like, and the invention is not intended to limit the manner of connecting the first flexible thin film. For instance, in another embodiment, each of the end points 312 and the end points 314 can be electrically connected by using the conductive material, and the two bonding regions 320 are fixed by additionally using an adhesive material.

In addition, in order to allow the first conductive lines 310 to be conveniently connected into the continuous spiral coil, the first conductive lines 310 may be obliquely arranged in this embodiment, as shown in FIG. 3B. In some other embodiments, a shape of the first flexible thin film can be a quadrilateral with an acute angle, and the first conductive lines are arranged to be parallel to one side of the four sides of the first flexible thin film. The invention is not intended to limit the first flexible thin film and the first conductive lines.

FIG. 5 is a schematic side view of a first flexible thin film according to another embodiment of the invention. A first flexible thin film 400 of FIG. 5 is similar to the first flexible thin film 300 of FIG. 3A, and a difference therebetween is that first conductive lines of the first flexible thin film 400 include a plurality of second conductive lines 410 and a plurality of third conductive lines 420. The first flexible thin film 400 has a first surface TS and a second surface BS opposite to each other. The second conductive lines 410 are disposed on the first surface TS of the first flexible thin film 400, and the third conductive lines 420 are disposed on the second surface BS of the first flexible thin film 400. Similar to the embodiment of FIG. 3A, in order to form the induction coil as shown in FIG. 4, the first flexible thin film 400 is rolled up such that two opposite sides of the first flexible thin film 400 are connected to form a cylinder-shaped structure. When the first flexible thin film 400 is rolled up into the cylinder-shaped structure, the second conductive lines 410 are electrically connected to the third conductive lines 420 to form an induction coil. A structure of the induction coil may be referred to as that provided in FIG. 4. In this way, the magnet 112 can move relative to the cylinder-shaped structure, as such, the induction coil generates an induced current. Implementation of forming the induction coil can be referred to as that described in the foregoing embodiments and therefore is not repeated herein.

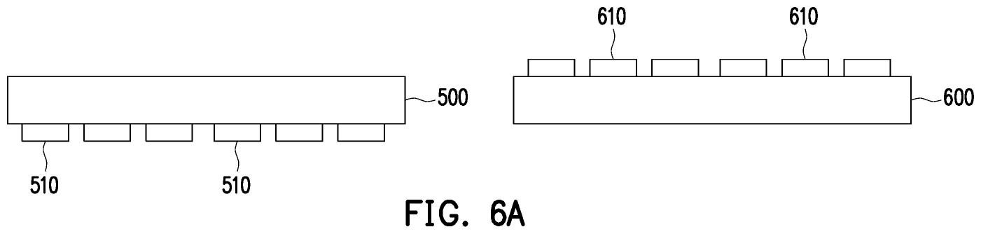

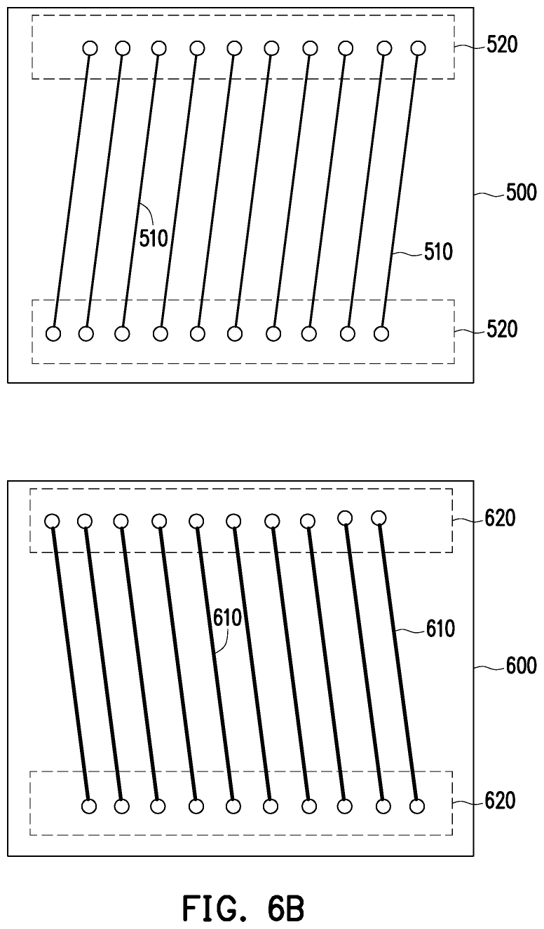

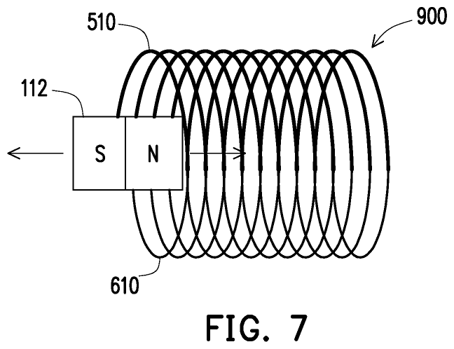

FIG. 6A is a schematic side view of a first flexible thin film and a second flexible thin film according to another embodiment of the invention, FIG. 6B is a schematic top view of the first flexible thin film and the second flexible thin film of FIG. 6A according to an embodiment of the invention, and FIG. 7 is a schematic view of the induction coil according to an embodiment of the invention. With reference to FIG. 6A and FIG. 6B, the induction coil of the electromagnetic induction generator 110 includes a first flexible thin film 500 and a second flexible thin film 600. A plurality of first conductive lines 510 and a plurality of fourth conductive lines 610 are respectively disposed on a surface of the first flexible thin film 500 and a surface of the second flexible thin film 600.

When the first flexible thin film 500 and the second flexible thin film 600 are horizontally disposed, at least two of the first conductive lines 510 are not electrically connected and at least two of the fourth conductive lines 610 are not electrically connected. When the first flexible thin film 500 and the second flexible thin film 600 are bent and laminated so that the first flexible thin film 500 and the second flexible thin film 600 form into a cylinder-shaped structure, the first conductive lines 510 are electrically connected to the fourth conductive lines 610 to form an induction coil 900 (as shown in FIG. 7). In this way, the magnet 112 can move relative to the cylinder-shaped structure, as such, the induction coil 900 generates the induced current. Magnetic poles of the magnet 112 is presented by N and S.

In this embodiment, both the first conductive lines 510 and the fourth conductive lines 610 are arranged in rows, and the first conductive lines 510 are arranged in an oblique direction opposite to that in which the fourth conductive lines 610 are arranged. In order to form a coil structure, that is, in order to connect the first conductive lines 510 and the fourth conductive lines 610, two opposite sides of the first flexible thin film 500 are connected to two opposite sides of the second flexible thin film 600. A method of connecting the first flexible thin film 500 and the second flexible thin film 600 of this embodiment is described in detailed as follows.

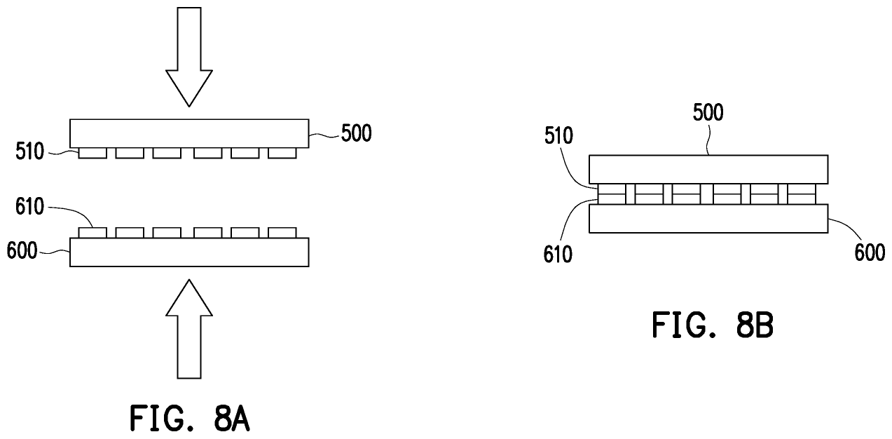

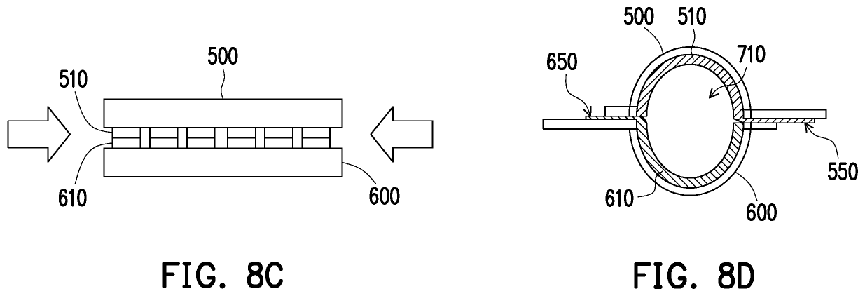

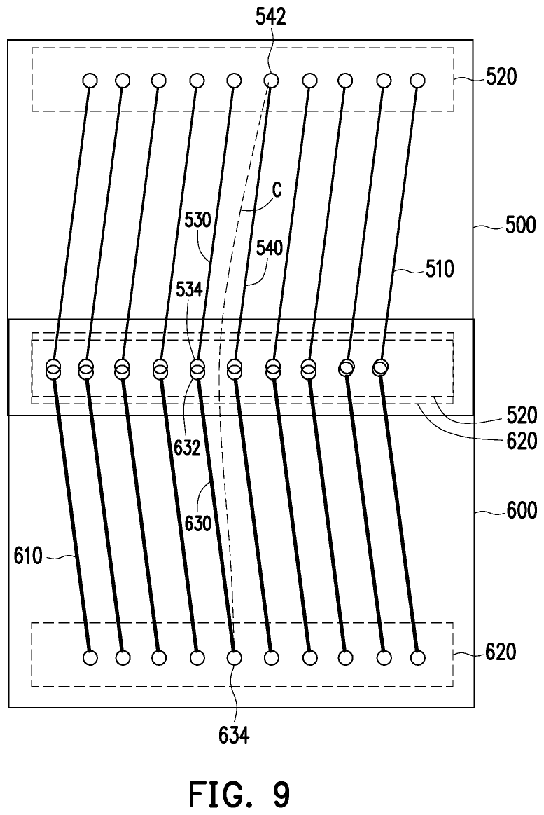

FIG. 8A to FIG. 8D are schematic diagrams of a connecting process of the first flexible thin film and the second flexible thin film of FIG. 6A according to an embodiment of the invention, and FIG. 9 is a schematic diagram of the connecting process with the first flexible thin film and the second flexible thin film of FIG. 8B being spread. To be specific, with reference to FIG. 8A and FIG. 8B first, the surfaces of the first flexible thin film 500 and the second flexible thin film 600 having the conductive lines are laminated to each other face to face. Two ends of each of the first conductive lines 510 are exposed on first bonding regions 520, and two ends of each of the fourth conductive lines 610 are exposed on second bonding regions 620. Portions of the first conductive lines 510 exposed on the first bonding regions 520 and portions of the fourth conductive lines 610 exposed on the second bonding regions 620 are bonded by using a conductive paste, so as to connect the first conductive lines 510 and the fourth conductive lines 610 at the first bonding regions 520 and the second bonding regions 620.

With reference to FIG. 9, one end of each of the fourth conductive lines 610 is connected to one of the two ends of the corresponding first conductive line 510, but the other end of each of the fourth conductive lines 610 is connected to the other end of the two ends of the conductive line (another first conductive line 510) next to the corresponding first conduction line 510. A conductive line 630 of the fourth conductive lines 610 is taken as an example for illustration. An end point 632 of the fourth conductive line 630 is connected to an end point 534 of a corresponding first conductive line 530 of the first conductive lines 510, and another end point 634 of the fourth conductive line 630 is connected to an end point 542 of another first conductive line 540 next to the first conductive line 530. The dotted line C indicates that the two end points are connected. How the rest of the first conductive lines 510 and the fourth conductive lines 610 are connected may be deduced by analogy.

With reference to FIG. 8C and FIG. 8D, lateral pressures are applied to the connected first flexible thin film 500 and the second flexible thin film 600, as such, central portions of the first flexible thin film 500 and the second flexible thin film 600 are separated, and a channel 710 is thereby formed between the first flexible thin film 500 and the second flexible thin film 600. The magnet 112 may move back and forth in the channel 710. When the first flexible thin film 500 and the second flexible thin film 600 form the cylinder-shaped structure, the first conductive lines 510 are electrically connected to the fourth conductive lines 610 to form a continuous three-dimensional spiral coil, such as the induction coil 900 shown in FIG. 7. In addition, in a contact point region 550 and a contact point region 650, contact points are provided for other lines to be electrically connected to the induction coil 900.

In another embodiment, roller double-sided printing may be adopted to manufacture a conductive pattern configured to form the induction coil on one surface of the first flexible thin film 500 and the second flexible thin film 600 and print other conductive patterns such as near field communication (NFC) lines on the other surface, so as to increase utilization rate and save layout space of the flexible thin films.

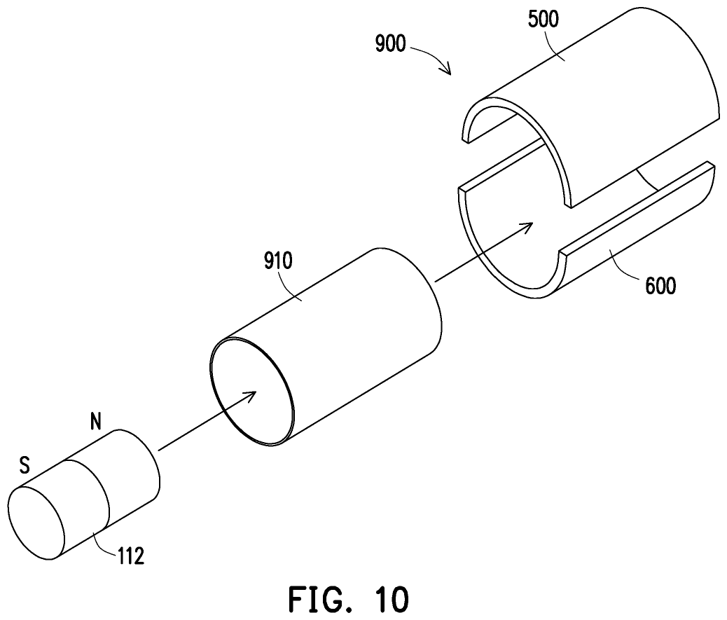

FIG. 10 is a schematic exploded view of an electromagnetic induction generator according to an embodiment of the invention. With reference to FIG. 10, the electromagnetic induction generator 110 further includes a sleeve 910. In this embodiment, the sleeve 910 is disposed in the induction coil 900, and the magnet 112 is disposed in the sleeve 910. The sleeve 910 is configured to allow the magnet 112 to move back and forth in the sleeve 910, as such, the magnetic flux passing through the induction coil 900 changes to generate the induced current. The sleeve 910 can prevent the first flexible thin film 500 or the second flexible thin film 600 from being scratched when the magnet 112 moves.

The sleeve 910 may be made of plastic or other non-metal materials, such as polyvinyl chloride (PVC) or acrylic and the like. The invention is not intended to limit the material type of the sleeve.

With reference to the embodiment of FIG. 2, the electromagnetic induction generator 110 may further include resilient devices 170. The resilient devices 170 may be disposed at end points of the sleeve 910 and configured to enable the magnet 112 moving to one end point of the sleeve 910 to move towards the other end point of the sleeve 910. When the magnet 112 moves to one of the end points of the sleeve 910 or to one of end points of the induction coil, the resilient device 170 applies a repulsive force to the magnet 112 to make the magnet 112 to leave the end point quickly. For instance, the resilient device 170 may be a magnet, and magnetism of one end of the resilient device 170 close to the magnet 112 is opposite to magnetism of the magnetic pole of the magnet 112 facing the resilient device 170, so that the magnet 112 is repelled. For instance, the resilient device 170 may be a spring, and when the magnet 112 moves to a bottom end and is in contact with the resilient device 170, the resilient device 170 applies an elastic force to push the magnet 112 back. The invention is not intended to limit the implementation of the resilient devices 170.

In view of the foregoing, the wearable electronic device provided by the embodiments of the invention includes the electromagnetic induction generator, the rectifier circuit, and the energy storage. The electromagnetic induction generator includes the magnet and the induction coil formed through the first flexible thin film. The magnet is disposed in the induction coil. When the wearable electronic device is moved, the magnet correspondingly moves in the induction coil to generate the induced current, and the energy storage is configured to convert the induced current into electrical energy and stores the electrical energy, so as to provide electric power required by the wearable electronic device. In the wearable electronic device provided by the embodiments of the invention, the kinetic energy can be converted into the electrical energy and the electrical energy is saved. Moreover, the densely-packed induction coil can be generated without considerably high manufacturing costs, and sufficient induced current is generated under limited weight and volume. The wearable electronic device can thereby be used for a longer period of time and thus feature advantages such as environmental protection and energy saving. Therefore, the wearable electronic device brings greater convenience to the user since the user does not have to put on or take off the wearable electronic device frequently for charging.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A wearable electronic device, comprising:
an energy storage, configured to store electric power;
an electromagnetic induction generator, comprising:
a first flexible thin film, provided with an induction coil; and
a magnet, wherein a magnetic flux passing through the induction coil changes so as to generate an induced current when a relative position between the magnet and the induction coil changes; and
a rectifier circuit, electrically connected to the induction coil and the energy storage and configured to receive the induced current to charge the energy storage.

2. The wearable electronic device as claimed in claim 1, wherein the electromagnetic induction generator further comprises a plurality of first conductive lines disposed on the first flexible thin film,
wherein at least two of the first conductive lines are not electrically connected when the first flexible thin film is horizontally disposed; and when the first flexible thin film is rolled up into a cylinder-shaped structure, the first conductive lines are electrically connected to form the induction coil so that the magnet can move in the cylinder-shaped structure to cause the induction coil to generate the induced current.

3. The wearable electronic device as claimed in claim 2, wherein the first conductive lines comprise a plurality of second conductive lines and a plurality of third conductive lines, the second conductive lines are disposed on a first surface of the first flexible thin film, and the third conductive lines are disposed on a second surface of the first flexible thin film, and
wherein when the first flexible thin film is rolled up into the cylinder-shaped structure, the second conductive lines are electrically connected to the third conductive lines to form the induction coil such that the magnet can move in the cylinder-shaped structure to cause the induction coil to generate the induced current.

4. The wearable electronic device as claimed in claim 1, wherein the electromagnetic induction generator further comprises a second flexible thin film, a plurality of first conductive lines disposed on the first flexible thin film, and a plurality of fourth conductive lines disposed on the second flexible thin film,
wherein when the first flexible thin film and the second flexible thin film are bent and laminated so that the first flexible thin film and the second flexible thin film are formed into a cylinder-shaped structure, the first conductive lines are electrically connected to the fourth conductive lines to form the induction coil such that the magnet can move in the cylinder-shaped structure to cause the induction coil to generate the induced current.

5. The wearable electronic device as claimed in claim 4, wherein at least two of the first conductive lines are not electrically connected and at least two of the fourth conductive lines are not electrically connected when the first flexible thin film and the second flexible thin film are horizontally disposed; and the first conductive lines are electrically connected to the fourth conductive lines to form the induction coil when the first flexible thin film and the second flexible thin film are formed into the cylinder-shaped structure.

6. The wearable electronic device as claimed in claim 1, wherein the electromagnetic induction generator further comprises:
a sleeve, configured to allow the magnet to move in the sleeve so that the magnetic flux passing through the induction coil changes so as to generate the induced current.

7. The wearable electronic device as claimed in claim 6, wherein the electromagnetic induction generator further comprises:
a resilient device, disposed at an end point of the sleeve and configured to enable the magnet moving to the end point of the sleeve to move towards another end point of the sleeve.

8. The wearable electronic device as claimed in claim 1, wherein the induction coil is made of at least one of an organic conductive polymer film, an indium tin oxide conductive film, metal, a carbon nanotube, and a graphene, and is formed on the first flexible thin film through at least one of a roll-to-roll printing and a screen printing.
